(19) United States
(12) Patent Application Publication
(10) Pub. No.: US 2026/0364731 A1
(43) Pub. Date: Nov. 19, 2026

(54) MACHINING DEVICE FOR SHAPING OPTICAL LENSES BY MATERIAL REMOVAL, HAVING A PRE-MACHINING MACHINE AND A FINISHING MACHINE

(71) Applicants: OptoTech Optikmaschinen GmbH, Jena (DE); TOOZ TECHNOLOGIES GMBH, Aalen (DE)

(72) Inventors: Georg Michels, Aalen (DE); Volker Bickel, Bischoffen (DE)

(21) Appl. No.: 19/477,701

(22) PCT Filed: Apr. 18, 2024
(86) PCT No.: PCT/EP2024/060559

§ 371 Date: Oct. 22, 2025

(30) Foreign Application Priority Data
Apr. 25, 2023 (DE) 10 2023 110 601.5

(51) Int. Cl. B24B 13/00; B24B 51/00

(52) U.S. Cl. CPC B24B 13/00; B24B 51/00

(57) ABSTRACT

The invention relates to a machining device (1) for shaping optical lenses (100) by material removal, having a pre-machining machine (10) and a finishing machine (30). The pre-machining machine (10) has a data output unit (12) which is configured to assign lens-specific geometry data (D) resulting from the pre-machining to the machined optical lens (100) and to output said data. The finishing machine (30) is controlled by a process controller (32) which is configured to design a finishing strategy of the finishing machine (30) on the basis of the output geometry data (D) for this optical lens (100) and to control the finishing machine (30) on the basis of this finishing strategy. The invention also relates to a method for the shaping finishing an optical lens (100).

### CROSS-REFERENCE TO RELATED APPLICATIONS

This application is a national phase under 35 U.S.C. 371 of International Application No. PCT/EP2024/060559 filed Apr. 18, 2024, which claims the benefit of and priority to German (DE) Patent Application No. 10 2023 110 601.5 filed Apr. 25, 2023, the contents of both of which being incorporated by reference in their entirety herein.

### TECHNICAL FIELD

The disclosure relates to a processing apparatus for the shape processing of optical lenses by material removal. The disclosure also relates to a method for the shape processing of optical lenses by material removal.

### BACKGROUND

The production of a spectacle lens by shape processing usually takes place starting from a spectacle lens blank by material removal on one or both sides. For economic reasons, this material removal is usually performed in multiple stages. Rough preprocessing takes place for example by milling or pre-turning with high removal rates, followed by a precise fine processing process step, for example diamond turning with a small setting, and a final finish process, for example polishing to smooth the previously generated regular surface structure.

It is known to carry out the first two process steps of rough and fine processing, and in particular milling and turning, on a single machine, as for example in DE 10 2006 050 425 A1. The finish process, in particular a smoothing polish process, is on the other hand carried out on a separate machine. Large material removal during the rough preprocessing requires correspondingly high processing forces, which in turn lead to machine vibrations, so that a parallel fine processing process on the same machine is not possible with sufficient quality. In combined milling and turning machines, the fine processing should therefore be carried out in working pauses of the rough processing. Moreover, the known processing strategies are inefficient and both the preprocessing and the fine processing take a long time.

It is therefore an object of the disclosure to optimize the efficiency of the preprocessing and fine processing of optical lenses, particularly in the production of spectacle lenses.

### BRIEF DESCRIPTION OF THE FIGURES

FIG. 1 shows a diagrammatic representation of a processing apparatus having a preprocessing machine and a fine processing machine;

FIG. 2 shows a diagrammatic cross section of an optical lens with a preprocessing target surface and a fine processing target surface;

FIG. 3a shows a schematic representation of a spiral processing path over an optical lens; and

FIG. 3b shows a schematic representation of a noncircular processing path over an optical lens.

### DETAILED DESCRIPTION

Main features of the disclosure are specified in the characterizing part of claim 1 as well as in claims 11 and 14. Claims 2 to 10, 12, 13 and 15 relate to embodiments.

The disclosure relates to a processing apparatus for the shape processing of optical lenses (this is also intended to mean optical lens blanks) by material removal, having a preprocessing machine and having a fine processing machine. The preprocessing machine should in particular be configured to achieve higher material removal rates than the fine processing machine.

One possible aspect of the disclosure consists in the preprocessing machine having a data output device, which is configured to assign lens-specific geometrical data resulting from the preprocessing to the processed optical lens and to output these data, the fine processing machine being driven by a process controller, which is configured to design a fine processing strategy of the fine processing machine based on the output geometrical data relating to this optical lens and to drive the fine processing machine based on this fine processing strategy.

In this way, with knowledge of the lens-specific geometrical data, it is possible to optimize the fine processing process, or the fine processing strategy, in respect of the processing time and manufacturing quality. By outputting and utilizing the geometrical data, the fine processing strategy may be adapted exactly to the actually existing input geometry (the geometrical data) so that the process time can be reduced significantly. Thus, according to the disclosure, information items are available concerning the surface shape actually manufactured in the preprocessing and therefore at least indirectly also the surface oversize as an input variable for designing the fine processing strategy. The geometry actually manufactured in the preprocessing machine is dependent on the target design to be manufactured, the installed tool geometry, the tool wear, the preprocessing strategy and the process parameters, for example feed, rotational speed, minimum oversize and machine accuracy.

Without the geometrical data being output and used, during the sequential processing on a preprocessing and fine processing machine the fine processing machine would have to work without knowledge of the actual surface oversize, or the oversize distribution on the processing surface of the optical lens after the preprocessing. In the simplest case, the processing strategy would then start with a sufficiently large safety margin from the optical lens and the processing strategy would be executed irrespective of whether the tool is engaged or is still at a distance from the optical lens. It is then at least necessary to trust that there is a sufficient surface oversize. As soon as the optical lens is intended to be approached more closely in rapid movement in order to shorten the processing strategy, it is necessary to trust that the maximum permissible surface oversize in relation to the fine processing target surface to be manufactured is not exceeded and there is no collision with the optical lens in the rapid movement. If there is doubt regarding these assumptions, special macros with a plurality of fine processing passes may be used, although this leads to an extended process time and in many cases would not be necessary. The decision as to whether such a macro with a plurality of passes is adopted might at best be made on the basis of a simulation calculation of the preprocessing process upstream of the fine processing process with the assumption of standardized parameters. Because of the geometrical data that are output according to the disclosure, the fine processing strategy can be designed much more precisely compared to solutions with such macros and the time of the fine processing strategy is shortened.

Furthermore, the feedback of the geometry manufactured in the preprocessing also ensures that preprocessing has actually taken place. If, for example because of a logistical error in the job control or because of a machine malfunction, an optical lens enters the fine processing machine without preprocessing, with uncompleted preprocessing, an operator error or unexpectedly high surface oversize, its further processing may be prevented in order to avoid waste, tool breakage, loss of productivity due to the necessary machine readjustment, etc.

The processing apparatus may on the one hand be formed as an integrated combination machine comprising the preprocessing machine and the fine processing machine, or on the other hand it may comprise the preprocessing machine and the fine processing machine as individual machines that can be used and/or set up independently of one another. Intermediate forms are also possible, in which the preprocessing machine and the fine processing machine share individual machine components, for example a common machine housing and/or a common control unit and/or a common machine bed.

In an integrated combination machine, on the one hand the preprocessing machine should comprise at least one tool for preprocessing by removing material and the data output device, and on the other hand the fine processing machine should comprise a tool for fine processing by removing material and the process controller. The data output device and the process controller may be embodied by a common control unit. The data output device is then optionally a purely digital data interface, in particular between different software modules for driving the preprocessing machine and the fine processing machine. It is possible for the preprocessing machine and the fine processing machine to share the machine bed, and/or share a workspace, and/or share a workpiece holder, and/or share a machine axis, and/or share a coolant circuit, and/or share a loading/unloading unit and/or share a user interface. In particular, the workspaces of the preprocessing machine and of the fine processing machine may be formed jointly or structurally separated from one another. In an embodiment of the processing apparatus with a common machine bed, the workpiece holder may for example also be shared by the preprocessing machine and fine processing machine.

In an embodiment with independent individual machines, the advantages of the disclosure are particularly appreciable since, via the data output device, the fine processing strategy of the fine processing machine may be designed while taking into account the resulting lens-specific geometrical data, although these data may also be used independently. For this purpose, the preprocessing machine and the fine processing machine optionally have mutually separate machine beds and/or separate control units. The workpiece holders and/or machine axes and/or workspaces and/or coolant circuits and/or a loading/unloading unit and/or a user interface are then optionally formed independently of one another. The data output device is then optionally a physical interface for the data output, for example a cable connection or an antenna. The individual machines may be set up next to one another. It is nevertheless also conceivable to set them up in different places.

An advantage of separated machine beds is that preprocessing and fine processing processes may run in parallel without the fine processing being influenced by vibrations of the rougher preprocessing. The time requirements for the preprocessing and fine processing of each optical lens may turn out to be very different, and essentially depend on the material, surface geometry to be produced and edge shape, or circumferential shape. With a view to mass production, this also offers the possibility that the installed preprocessing and fine processing capacities can be kept demand-based and mutually independent, so that for example one preprocessing machine may be combined with two fine processing machines. The machine design and suitable optimization for the respective process are simplified.

Separated control units enable the use of individual driving software, which is correspondingly less complex. Machines of different generations or even from different manufacturers may also be combined with one another.

The preprocessing machine preferentially has a milling tool. More rapid material removal is thereby possible.

The fine processing machine preferentially has a turning tool. With the latter, even freeform surfaces may be manufactured precisely, for example by coupling feeds of the turning tool to the angle of rotation of the optical lens.

Alternatively, the preprocessing machine may also have a turning tool, the tool radius or effective tool cutting geometry of which is larger than that of the turning tool of the fine processing machine. With a larger radius, or larger cutting geometries, higher material removal rates can be achieved.

Optical lenses usually have a front side, an opposite rear side and a lens circumference, which delimits the front side and rear side. At least before it is processed, the lens circumference may be circular.

Correspondingly, the lens-specific geometrical data may optionally describe a front side, a rear side, a circumferential surface (which may also be referred to as a lateral surface) and/or facet of the optical lens. At least one surface from the group: front side, rear side, circumferential surface and facet is thus described.

During spectacle lens manufacture, a convex front side and a concave rear side are usually produced. An optical lens blank may for this purpose already have a convex front side and a concave rear side. In many cases, only the concave rear side is further shaped by processing in order to produce the optical effect of the optical lens according to a prescription for correcting a visual defect. Nevertheless, shape processing of the convex front side is also possible as an alternative or in addition.

The preprocessing machine should in principle be formed in order to produce a preprocessing target surface from the optical lens. Because of technical constraints or for the sake of process efficiency, the surface actually manufactured and therefore also the geometrical data may deviate from this preprocessing target surface. If the intention is to achieve a defined fine processing target surface at the end of the fine processing, it is useful to define the preprocessing target surface indirectly by a setpoint oversize in relation to the fine processing target surface.

The fine processing machine should be formed in order to produce the fine processing target surface starting from the lens-specific geometrical data resulting from the preprocessing. Achieving the objective requires the technically necessary tools. The fine processing target surface is ultimately the surface that is to achieve the optically desired effect during subsequent use. Accordingly, unlike in the preprocessing, surface deviations are not permissible in this case merely because the processing process is meant to take place more rapidly or the corresponding tools are not available.

When the target surface of the preprocessing has high surface curvatures, for example for spectacle lenses with a strong positive effect fitted to standard diameters, material may not be removed to the desired minimum oversize in the regions of strong curvature in the preprocessing process. Either the preprocessing machine cannot achieve the specified preprocessing target surface in the first place, or the decision is made to permit deviations deliberately in order to shorten the process. The geometrical data actually resulting then deviate from the preprocessing target surface. For example, the tool geometry is a limiting factor for the achievability of the preprocessing target surface. Smaller tools, or tool radii, extend the range toward more strongly curved surfaces but reduce the efficiency of the preprocessing process. In the extreme case, the same delicate tool geometry would be needed for the preprocessing tool as for the fine processing. It is therefore uneconomical to slow the preprocessing process in this way by selecting small tools. Rather, it is expedient to equip preprocessing machines with tools having a different geometry adapted to the production spectrum, which then necessarily leads to an increased variance of the oversize distribution as an input geometry for the fine processing process. Here, the advantages of the geometrical data that are output according to the disclosure are fully exploited since the preprocessing machine makes these geometrical data relating to the surface actually manufactured available for the subsequent fine processing.

The processing strategy of the preprocessing machine may thus be optimized. The limits for the design of the processing strategy of the preprocessing machine may be set with the aid of whatever allows the fine processing machine to work efficiently, for example by defining a permissible maximum oversize.

An edge geometry manufactured in the preprocessing process, or the feedback as to whether edge processing has taken place at all, makes it possible to start up the tools during the fine processing in rapid movement as far as a minimum safety distance, before the process-relevant feed rate then comes into effect. The latter is usually less than the rapid movement speed, so that this results in a reduction of the process time.

In a preferred solution according to the disclosure, the preprocessing machine assigns the resulting lens-specific geometrical data of the preprocessed optical lens to the job and sends them to the fine processing machine as input parameters together with the other usual job parameters and manufacturing parameters. Since the actual outcome of the preprocessing is now the input variable for the fine processing, a simulation calculation on the fine processing machine with reconstruction or approximation of the preprocessing is not required.

The availability of the oversize distribution, or of the geometrical data and the oversize distribution derived therefrom, also offers the possibility of further optimizing and accelerating the fine processing. If the surface oversize exceeds the maximum desired or permissible setting, it is not necessary to adjust the desired surface oversize for the last fine cut with a corresponding number of preliminary cuts by approximately replicating the rotational speed profile and feed profile/track groove widths in each pass with a modified setting. Instead, when there is a high but locally limited surface oversize, according to the disclosure, with the aid of knowledge of this local distribution characteristic in regions where no material removal is expected and the fine processing tool so to speak runs through air, the time per pass can be reduced by increasing the feed/track groove width. If a constant tool setting relative to the center of the spindle is assumed, there will be variable annular concentric zones that are run over with a differently modified radial setting in the fine processing process. The radial setting per spindle revolution in zones where no material removal takes place may readily be increased according to the disclosure by ten to one hundred times compared to the zones with material removal.

In the case of spectacle lenses with a strong positive effect fitted to standard diameters, the region with an increased surface oversize is annular only in special cases. The previously described division into annular zones with different radial feed values may already lead to a significant reduction of the processing time. A further optimization is, however, possible if the zones with a different feed are not assumed to be annular but instead they are adapted to the regions with maximum surface oversize, in such a way that these regions can be run over with a minimum number of spindle revolutions. A first approximated variant consists, for example, in forming these zones elliptically. The radial tool setting with respect to the center of the spindle would in this case no longer be constant but instead superimposed in an oscillating fashion. The radial tool setting with respect to the center of the spindle is then coupled to the angle of rotation of the optical lens. The fine processing may as it were be subdividable, or subdivided, into an oversize homogenization with an oscillating radial tool setting with respect to the center of the spindle and final processing in order to remove the homogenized surface oversize. The quality of the final processing is high owing to the homogeneous penetration depth of the tool which is then possible.

According to the disclosure, the process controller of the fine processing machine should have a data interface for receiving the geometrical data from the data output device of the preprocessing machine. The data interface may be formed directly between the preprocessing machine and the fine processing machine. Alternatively, however, an indirect data interface is also possible via a master computer system or via a data carrier physically assigned to the optical lens.

Further, the preprocessing machine should be driven by a process controller which is configured to design a preprocessing strategy of the preprocessing machine based on a preprocessing target surface and to drive the preprocessing machine based on this preprocessing strategy. The lens-specific geometrical data resulting from the preprocessing may deviate from the preprocessing target surface, in particular also because the preprocessing strategy deliberately provides for this. Particularly, the preprocessing target surface may have an at least substantially or exactly homogeneous surface oversize in relation to the fine processing target surface. The surface oversize actually produced, which occurs between the geometrical data and the fine processing target surface, may on the other hand turn out to be inhomogeneous. Accordingly, the lens-specific geometrical data may comprise a surface shape actually manufactured in the preprocessing machine. There is thus then a discrepancy between the surface that the preprocessing machine should ideally manufacture (preprocessing target surface) and the surface actually manufactured (the geometrical data); the preprocessing machine imparts information relating to this by means of the geometrical data.

Optionally, the process controller of the preprocessing machine is configured to design the preprocessing strategy while complying with a maximum exceedance of the surface oversize in relation to the preprocessing target surface and/or in relation to the fine processing target surface. The preprocessing time may therefore be reduced by the tool selection because the processing speed can be increased at the cost of the preprocessing precision. Up to a maximum exceedance of the local surface oversize, the further processing, and in particular the equalization of the preprocessing deviation, may be left to the fine processing machine.

Especially, the fine processing strategy designed by the process controller of the fine processing machine comprises tool paths, tool movements and/or movements of the optical lens.

In one particular embodiment, either the lens-specific geometrical data comprise an information item relating to the surface oversize in relation to a fine processing target surface of the fine processing machine, the information item relating to the surface oversize being output by the data output device of the preprocessing machine, or an information item relating to the surface oversize in relation to a fine processing target surface of the fine processing machine is calculated by the process controller of the fine processing machine based on the lens-specific geometrical data. Through the surface oversize, the fine processing machine ascertains where it still needs to remove material and how much material it still needs to remove. These information items are as a general rule already available to the preprocessing machine since its preprocessing target surface is preferentially to be determined based on the fine processing target surface. Correspondingly, the surface oversize actually manufactured may also be provided to the fine processing machine in order to avoid recalculation on the part of the fine processing machine.

Optionally, the data output device may be configured to output the lens-specific geometrical data in the form of a surface point cloud or mathematical formula (for example respectively in a Cartesian, cylindrical or spherical coordinate system). The data quantity increases correspondingly with an increasing number of data points. In order to avoid large quantities of data, it may be sufficient for the geometrical data to have fewer data points than the fine processing target surface. It may in fact be sufficient to approximate the surface oversize between the data points. If there are minimal deviations of the oversize between the assumption and the actual surface, the tool of the fine processing machine equalizes them during the processing. Conversely, the fine processing target surface must be manufactured precisely in respect of the optical effect.

Moreover, the data output device may be configured to output the lens-specific geometrical data including at least one further information item from the group: center thickness, rotational position, decentering, circumferential shape, facet geometry, prism angle or blocker data. These further information items facilitate the reception and alignment of the optical lens in the fine processing machine. The process controller of the fine processing machine may also take the further information items into account when designing the fine processing strategy.

In particular, faceting of the lens edge may be envisioned as a facet geometry. The transition from the lens edge to the surface to be processed is as a rule already provided within the preprocessing process with a linear chamfer having a particular angle or a chamfer tangentially adjoining the processing surface and/or the lens circumference. This may take place in a movement of the milling tool during the pouring after the edge processing into the surface to be processed, subsequent to the edge processing and before the surface processing without direct pivoting in or subsequent to the edge and surface preprocessing. During the fine processing which then follows, the material removal is so small, usually of the order of 0.1 to 0.2 mm, that the previously manufactured facet is preserved, or the extent of removal to be expected is kept “rough”. The facet has on the one hand a cosmetic reason, but also a technological reason. For instance, the tool wear in the subsequent polish process may be reduced significantly with a correctly dimensioned facet.

The blocker data may consist of the way in which an optical lens blank is secured to a block. Spectacle lens blanks exist in a large number of variants in respect of the front curvatures because of the desired effect of the finished spectacle lens as well as owing to the material or manufacturer. In order to be able to cope with this variety straightforwardly in production, standardized universal blocks are used, on which the blank to be processed is fixed by means of alloy, wax, plastic, vacuum, etc., and can therefore be processed or measured with the same mounting reference in the various machines. Through the alignment of the blank with the axis of the standardized universal block, the prism to be manufactured may also be adjusted in position and direction and the cylinder axis in conventional toric manufacture may be defined.

The geometrical data may optionally be defined by an approximated envelope surface, so that the actual surface manufactured during the preprocessing always lies on the envelope surface (that is to say, the local surface oversize may locally be somewhat greater than as described by the envelope surface) or between the envelope surface and the fine processing surface (that is to say, the local surface oversize may locally be somewhat less than as described with the envelope surface). By an envelope surface, the data quantity may be reduced in relation to a complete description of the manufactured surface. The existing surface oversize is worked out by subtracting the final surface geometry (the fine processing target surface) and the fine processing strategy, including the tool paths, can be calculated for the fine processing machine irrespective of the type of preprocessing strategy used. In this case, it is useful for the preprocessing machine to output the geometrical data relating to the manufactured surface shape of the optical lens in the same data format as that in which it itself obtains the target surface to be created. This avoids information losses due to data conversion. If possible, the process controller of the fine processing machine should also design the fine processing strategy without conversion of the geometrical data.

In another variant, the geometrical data comprise a surface oversize actually existing in relation to the fine processing target surface. This has the advantage that the oversize distribution is immediately apparent on the fine processing machine. The revised difference calculation at a multiplicity of surface points is therefore obviated on the part of the process controller of the fine processing machine and a necessary cut distribution can be designed more rapidly.

The machines may receive the target surfaces to be manufactured via a master computer system. A central data interface via the master computer system is therefore also favorable in order to transfer the output geometrical data to the process controller of the fine processing machine. It would also be conceivable for the fine processing machine to request the geometrical data from the preprocessing machine preceding it in the process sequence, and for the latter then to provide these data by output. With both variants, reliable determination of the surface oversize and the cut distribution for the fine processing strategy is straightforwardly possible irrespective of the machine, tool and parameter configuration with which the preprocessing has taken place.

It has proven favorable for the preprocessing machine to be configured to produce an only substantially homogeneous surface oversize in relation to the fine processing target surface that is to be produced in the fine processing machine based on a preprocessing target surface, a defined minimum oversize being complied with over the entire surface. The preprocessing may thus take place rapidly and efficiently. Optionally, a defined maximum oversize may be complied with over the entire surface. This avoids inefficient reprocessing on the part of the fine processing machine, which is not designed for large material removal.

The disclosure also relates to a method for the shape processing of optical lenses (this also includes optical lens blanks) by material removal, comprising the following steps:
(a) processing an optical lens by removing material with a preprocessing machine;
(b) outputting lens-specific geometrical data relating to the optical lens, which result from the preprocessing, with a data output device of the preprocessing machine and assigning the geometrical data to the preprocessed optical lens;
(c) designing a fine processing strategy of a fine processing machine in order to produce a fine processing target surface by a process controller based on the output geometrical data of the data output device of the preprocessing machine relating to this optical lens; and
(d) driving the fine processing machine according to the fine processing strategy and producing a fine processing target surface, in particular by material removal.

The effect thereby achieved is that the fine processing strategy is designed efficiently with knowledge of the geometrical data, instead of only making the assumption that the preprocessing machine has actually fulfilled a target specification.

The method is particularly advantageous when the preprocessing machine and the fine processing machine have mutually separated machine beds and/or separate control units. Despite the machine division, the preprocessing machine and the fine processing machine can then work efficiently.

The method may, in particular, be implemented with all optional embodiment variants of the processing apparatus described above. The indications given for use of the processing apparatus and its described effects are also to be understood as features that may be correspondingly implemented for the method. The optional embodiment variants of the processing apparatus are therefore also optional developments of the method.

Conversely, it is within the scope of the disclosure for the above embodiment variants of the processing apparatus to be developed by an embodiment for carrying out the method.

The disclosure also relates to a method for the shape fine processing of an optical lens (this also includes optical lens blanks) by material removal with a turning tool in a turning process, wherein the optical lens is driven in rotation about a spindle axis and wherein a starting surface having an inhomogeneous surface oversize in relation to a fine processing target surface is processed with the turning tool, in which the following steps are carried out:
(a) at least one oversize homogenization step by addressing the starting surface with the turning tool in a noncircular orbit about the spindle axis by modulating a radial setting of the turning tool (that is to say, transversely with respect to the spindle axis), with zones of the inhomogeneous surface oversize comprising an increased surface oversize in relation to the fine processing target surface lying on the noncircular orbit, and modulating the axial setting of the turning tool (that is to say, along the spindle axis) in order to produce a homogeneous target oversize in relation to the fine processing target surface, the penetration depth of the turning tool into the optical lens varying over the orbit; and
(b) a final processing step, in which the target oversize in relation to the fine processing target surface is removed with an at least substantially constant penetration depth of the turning tool over the orbit until the fine processing target surface.

The effect thereby achieved is that the surface can be run over homogeneously in the final processing step, the track grooves are continuous and the track groove widths are constant. It can be done in this fine processing strategy in particular even if the starting surface is the result of a preprocessing strategy that provides only an inhomogeneous oversize in relation to the fine processing target surface.

In this method, the starting surface may correspond to the geometrical data of the method just described, and this method may in particular be employed within the method described above.

It then forms a foundation for the fine processing strategy.

Further features, details and advantages of the disclosure may be found from the wording of the claims and from the following description of exemplary embodiments with the aid of the drawings, in which:

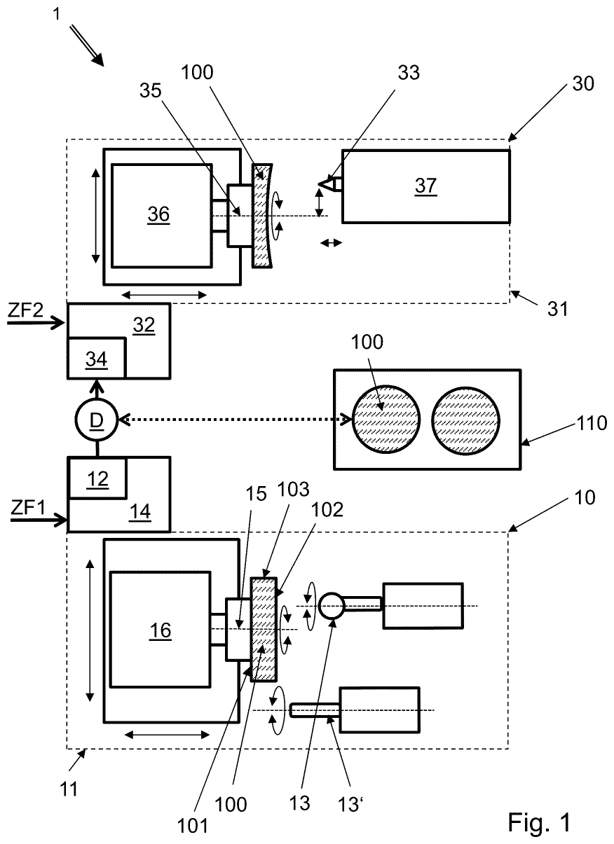

FIG. 1 diagrammatically represents a processing apparatus 1 for the shape processing of optical lenses 100 by material removal, which has a preprocessing machine 10 and a fine processing machine 30.

The preprocessing machine 10 has two milling tools 13, 13′ for processing the optical lens 100. The optical lens 100 comprises a front side 101, an opposite rear side 102 and a lens circumference 103, which delimits the front side 101 and rear side 102 at their respective circumference. One of the milling tools 13 serves in the present case to process the rear side 102, of the lens circumference 103 or of a facet at the transition of the lens circumference 103 to the rear side 102. The other of the milling tools 13′ serves at least primarily to process the lens circumference 103. The milling tools 13, 13′ are each driven in rotation. The optical lens 100 is also driven by a spindle drive 16, which drives the optical lens 100 in rotation about a spindle axis 15. This spindle drive 16 is seated on a compound slide, so that the optical lens 100 can be displaced transversely and longitudinally with respect to the spindle axis 15. The spindle axis 15 is in the present case aligned parallel to the axes of rotation of the milling tools 13, 13′. Nevertheless, different kinematics may likewise be implemented. The milling tools 13, 13′ and the spindle drive 16 are seated on a common machine bed 11.

The preprocessing machine 10 is driven by a process controller 14, which is configured to design a preprocessing strategy of the preprocessing machine 10 based on a preprocessing target surface ZF1 and to drive the preprocessing machine 10 based on this preprocessing strategy. The process controller 14 may be secured to the machine bed 11, although it is preferentially set up with vibration decoupling and optionally separately from the machine bed 11.

The preprocessing machine 10, in particular its process controller 14, has a data output device 12 which is configured to assign lens-specific geometrical data D resulting from the preprocessing to the processed optical lens 100 and to output these data.

The geometrical data D should remain physically or logically linked with the processed optical lens 100 in particular even after leaving the preprocessing machine 10. During spectacle lens production, it is usual to transport the optical lens 100 further after its preprocessing as a lens pair for the spectacles in a transport container 110 (also known as a tray).

Subsequent to the preprocessing in the preprocessing machine 10, the optical lens 100 is delivered to the fine processing machine 30, in the present case by the diagrammatically represented transport container 110.

The fine processing machine 30 has a turning tool 33, which is driven in oscillation by a servo or oscillation drive 37 (also referred to as a fast tool). The optical lens 100 is driven by a spindle drive 36 in rotation about a spindle axis 35, the spindle drive 36 being seated on a compound slide in order to move the optical lens 100 along the spindle axis 35 axially toward or away from the turning tool 33 and in order to move the optical lens 100 transversely with respect to the spindle axis 35 past the turning tool 33. For example, the turning tool 33 may manufacture freeform surfaces by feeds of the turning tool 33 being coupled to the angle of rotation of the optical lens 100. The spindle drive 36 and the servo or oscillation drive 37 are seated on a common machine bed 31.

The machine bed 11 of the preprocessing machine 10 and the machine bed 31 of the fine processing machine 30 are physically separated from one another, particularly in order to decouple the vibrations. The preprocessing machine 10 and the fine processing machine 30 are in the present case machines that can be operated independently of one another.

The fine processing machine 30 is driven by a process controller 32, which is configured to design a fine processing strategy of the fine processing machine 30 based on the output geometrical data D relating to this optical lens 100 and to drive the fine processing machine 30 based on this fine processing strategy. The process controllers 32 is optionally also set up with vibration decoupling and optionally separately from the machine bed 31. The process controllers 14 and 32 are in this case implemented in separate control units of the preprocessing machine 10 and of the fine processing machine 30.

Further, the process controller 32 of the fine processing machine 30 has a data interface 34 for receiving the geometrical data D from the data output device 12 of the preprocessing machine 10. As an alternative to the direct data connection shown, with which the fine processing machine 30 optionally requests the preprocessing machine 10 for the geometrical data D of the optical lens 100 about to be processed, communication via a master computer system or alternatively data transfer via a data carrier, which is assigned to the optical lens 100 or to its transport container 110, may also be envisioned.

The fine processing machine 30 thus precisely obtains geometrical data D resulting precisely from the preprocessing. It therefore does not need to trust that the preprocessing machine 10 has achieved the preprocessing target surface ZF1 or to approximate any deviations therefrom. Rather, the preprocessing machine 10 is even given latitude to deviate from the preprocessing target surface ZF1 for processing economy. The preprocessing target surface ZF1 is after all only an intermediate working state, without optical applications of the optical lens 100 having to be carried out with it. Especially, the preprocessing machine 10, in particular its process controller 14, may be configured to produce an only substantially homogeneous surface oversize A in relation to the fine processing target surface ZF2 that is to be produced in the fine processing machine 30 based on the preprocessing target surface ZF1, a defined minimum oversize being complied with over the entire surface. At the same time, a defined maximum oversize should be complied with over the entire surface since it subsequently has to be removed by the fine processing machine 30.

The fine processing strategy designed by the process controller 32 of the fine processing machine 30 determines tool paths, tool movements and/or movements of the optical lens, in particular while taking into account the geometrical data D obtained. The lens-specific geometrical data D should describe at least the front side 101, the rear side 102 and/or the circumferential surface 103 of the optical lens 100. Above all, the surfaces processed by the preprocessing machine 10 should be part of the geometrical data D. Unmodified surfaces may also be provided from a different data source, for example a machine database relating to the optical lens 100 or a master computer system.

In addition, the lens-specific geometrical data D may for example comprise an information item relating to the surface oversize A in relation to the fine processing target surface ZF2 of the fine processing machine 30, the information item relating to the surface oversize A being output by the data output device 12 of the preprocessing machine 10. Alternatively, an information item relating to the surface oversize A in relation to the fine processing target surface ZF2 of the fine processing machine 30 may be calculated by its process controller 32 based on the lens-specific geometrical data D.

Optionally, the data output device 12 may be configured to output the lens-specific geometrical data D including at least one further information item from the group: center thickness, rotational position, decentering, circumferential shape, facet geometry, prism angle or blocker data.

The data output device 12 may be configured to output the lens-specific geometrical data D in the form of a surface point cloud or mathematical formula.

With this processing apparatus 1, a method may now be carried out for the shape processing of optical lenses 100 by material removal, comprising the following steps:
(a) processing the optical lens 100 by removing material with the preprocessing machine 10;
(b) outputting lens-specific geometrical data D relating to the optical lens 100, which result from the preprocessing, with a data output device 12 of the preprocessing machine 10 and assigning the geometrical data D to the preprocessed optical lens 100;
(c) designing a fine processing strategy of the fine processing machine 30 in order to produce the fine processing target surface ZF2 by the process controller 32 based on the output geometrical data D of the data output device 12 of the preprocessing machine 10 relating to this optical lens 100;
(d) driving the fine processing machine 30 according to the fine processing strategy and producing the fine processing target surface ZF2.

The material removal may take place with the turning tool 33 in a turning process, the optical lens 100 being driven in rotation about the spindle axis 35. A starting surface F, defined by the geometrical data D, having an inhomogeneous surface oversize A in relation to the fine processing target surface ZF2 may then be processed in two stages. In particular, an oversize homogenization step may initially take place by addressing the starting surface F with the turning tool 33. A modulation of the axial setting of the turning tool 33, in which the penetration depth of the turning tool 33 into the optical lens 100 varies over the orbit, is in this case carried out in order to produce a homogeneous target oversize in relation to the fine processing target surface ZF2. Optionally, it is possible for this to be done in a noncircular orbit about the spindle axis 35 by modulating a radial setting of the turning tool 33, with zones of the inhomogeneous surface oversize A comprising an increased surface oversize A1 in relation to the fine processing target surface ZF2 lying on the noncircular orbit. A final processing step may subsequently take place, in which the target oversize in relation to the fine processing target surface ZF2 is removed with an at least substantially constant penetration depth of the turning tool 33 over the orbit until the fine processing target surface ZF2. The orbit is optionally circular (this is also meant to include the spiral shape).

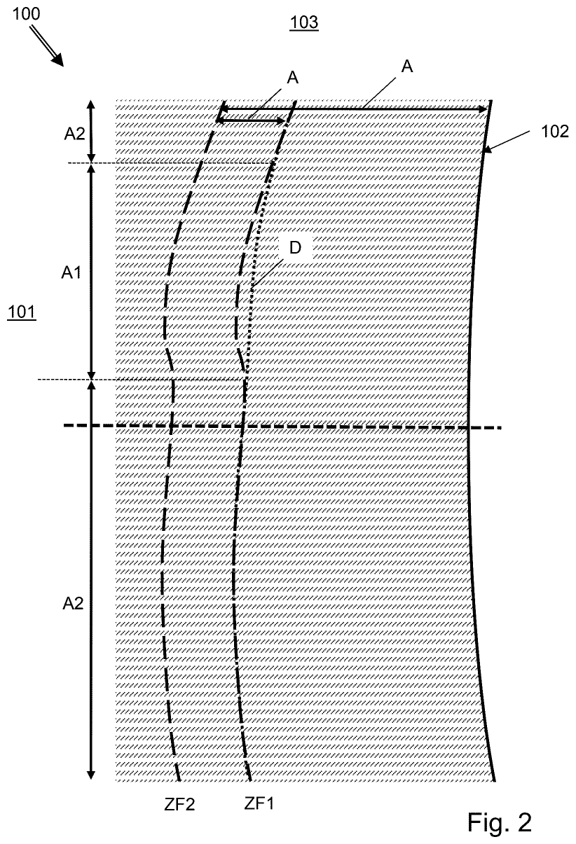

FIG. 2 shows a diagrammatic cross section of an optical lens 100, which contains a partial detail of the rear side 102, with the front side 101 and the circumference 103 only being indicated. Starting from the rear side 102, which is produced for example in previous processing or alternatively in a casting method, a fine processing target surface ZF2 is intended to be achieved by two-stage processing in which material is removed. A preprocessing target surface ZF1 may in this case be specified to a preprocessing machine 10, as described above, or alternatively the preprocessing target surface ZF1 is determined by the preprocessing machine 10 based on the fine processing target surface ZF2 and, for example, a minimum oversize. Because of the tool geometry or restrictions in respect of the freedom of movement of the tool relative to the optical lens 100, it may be necessary to deviate from the preprocessing target surface ZF1 having a homogeneous surface oversize A in relation to the fine processing target surface ZF2. The surface of the preprocessing that is actually manufactured then corresponds to the geometrical data D, and complies both with the minimum surface oversize A in relation to the fine processing target surface ZF2 and with a maximum surface oversize. As represented, this results in zones A2 of the inhomogeneous surface oversize A that have a small surface oversize as well as zones A1 that have an increased surface oversize.

The inhomogeneous surface oversize A is subsequently to be processed further with a fine processing machine, for example such as described above.

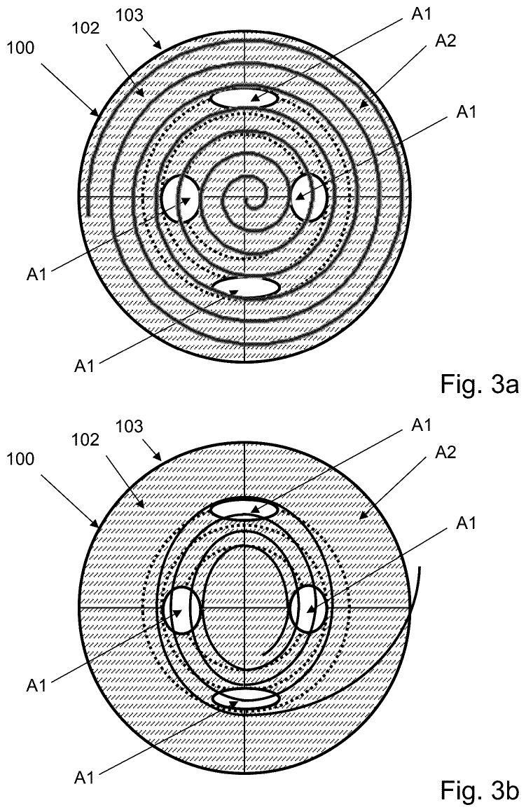

In this regard, FIG. 3a gives a schematic representation of a spiral processing path over an optical lens 100. It may be seen that zones A1 with an increased surface oversize lie in two concentric rings inside a zone A2 with a small, homogeneous surface oversize. The entire rear side 102 is addressed with the diagrammatically represented spiral processing path, which can be achieved by constant transverse movement of the tool and a constant speed of rotation of the optical lens 100, in which case under certain circumstances, depending on the setting, only the zones A1 with an inhomogeneous increased surface oversize are removed and the turning tool floats over the surface between them. The processing path could be restricted by a rapid movement to the regions between the concentric rings with the zones A1 having an inhomogeneous increased surface oversize, in order first to remove the zones A1 with an inhomogeneous increased surface oversize.

It has, however, proven particularly efficient for the radial setting of the tool to be modulated as a function of the angle of rotation, as diagrammatically represented in FIG. 3b, so that a noncircular processing path is addressed. In comparison with the spiral trajectory according to FIG. 3a, that of the diagrammatically represented procedure according to FIG. 3b is not only shortened but also compressed into an elliptical shape in order to address all zones A1 with an inhomogeneous increased surface oversize with fewer revolutions. In this way, a homogeneous surface oversize may initially be generated. Only during the final processing should the entire relevant surface of the optical lens 100 be addressed once more spirally and with a constant penetration depth of the turning tool.

The disclosure is not restricted to one of the embodiments described above, but may be modified in a variety of ways.

All features and advantages emerging from the claims, the description and the drawing, including design details, spatial arrangements and method steps, may be essential to the disclosure both individually and in a wide variety of combinations.

List of references

| | |
|---|---|
| 1 | processing apparatus |
| 10 | preprocessing machine |
| 11 | machine bed |
| 12 | data output device |
| 13 | milling tool |
| 14 | process controller |
| 15 | spindle axis |
| 16 | spindle drive |
| 30 | fine processing machine |
| 31 | machine bed |
| 32 | process controller |
| 33 | turning tool |
| 34 | data interface |
| 35 | spindle axis |
| 36 | spindle drive |
| 37 | servo drive/oscillation drive/fast tool |
| 100 | optical lens |
| 101 | front side |
| 102 | rear side |
| 103 | circumferential surface |
| 110 | transport container (tray) |
| A | surface oversize |
| A1 | zones of the inhomogeneous surface |
| | oversize comprising an increased |
| | surface oversize |
| A2 | zones of the inhomogeneous surface |
| | oversize comprising a small surface |
| | oversize |
| D | geometrical data (which result from |
| | the preprocessing and are lens- |
| | specific) |
| F | starting surface |
| ZF1 | preprocessing target surface |
| ZF2 | fine processing target surfac |

1. A processing apparatus for shape processing of optical lenses by material removal, having a preprocessing machine and having a fine processing machine, wherein:
the preprocessing machine has a data output device, which is configured to assign lens-specific geometrical data (D) resulting from the preprocessing to the processed optical lens, and to output these data, and
the fine processing machine is driven by a process controller, which is configured to design a fine processing strategy of the fine processing machine based on the output geometrical data (D) relating to this optical lens and to drive the fine processing machine based on the fine processing strategy.

2. The processing apparatus as claimed in claim 1, wherein the process controller of the fine processing machine has a data interface for receiving the geometrical data (D) from the data output device of the preprocessing machined.

3. The processing apparatus as claimed in claim 1, wherein the preprocessing machine is driven by a process controller, which is configured to design a preprocessing strategy of the preprocessing machine based on a preprocessing target surface (ZF1) and to drive the preprocessing machine based on the preprocessing strategy.

4. The processing apparatus as claimed in claim 1, wherein the fine processing strategy designed by the process controller of the fine processing machine comprises tool paths, tool movements, or movements of the optical lens.

5. The processing apparatus as claimed in claim 1, wherein the lens-specific geometrical data (D) describe a front side, a rear side, a circumferential surface, or facet of the optical lens.

6. The processing apparatus as claimed in claim 1, wherein:
a) the lens-specific geometrical data (D) comprise an information item relating to the surface oversize (A) in relation to a fine processing target surface (ZF2) of the fine processing machine, the information item relating to the surface oversize (A) being output by the data output device of the preprocessing machine; or
b) an information item relating to the surface oversize (A) in relation to a fine processing target surface (ZF2) of the fine processing machine is calculated by the process controller of the fine processing machine based on the lens-specific geometrical data (D).

7. The processing apparatus as claimed in claim 1, wherein the data output device is configured to output the lens-specific geometrical data (D) in the form of a surface point cloud or mathematical formula.

8. The processing apparatus as claimed in claim 1, wherein the data output device 4) is configured to output the lens-specific geometrical data (D) including at least one further information item from the group: center thickness, rotational position, decentering, circumferential shape, facet geometry, prism angle, or blocker data.

9. The processing apparatus as claimed in claim 1, wherein the preprocessing machine is configured to produce an only substantially homogeneous surface oversize in relation to the fine processing target surface (ZF2) that is to be produced in the fine processing machine based on a preprocessing target surface (ZF1), a defined minimum oversize being complied with over the entire surface.

10. The processing apparatus as claimed in claim 9, wherein a defined maximum oversize is complied with over the entire surface.

11. A method for shape processing of optical lenses by material removal, comprising:
(a) processing an optical lens by removing material with a preprocessing machine;
(b) outputting lens-specific geometrical data (D) relating to the optical lens, which result from the preprocessing, with a data output device, of the preprocessing machine and assigning the geometrical data (D) to the preprocessed optical lens;
(c) designing a fine processing strategy of a fine processing machine in order to produce a fine processing target surface (ZF2) by a process controller based on the output geometrical data (D) of the data output device of the preprocessing machine relating to this optical lens;
(d) driving the fine processing machine according to the fine processing strategy and producing a fine processing target surface (ZF2).

12. The method as claimed in claim 11, wherein the preprocessing machine and the fine processing machine have mutually separated machine beds or separate control units.

13. The method as claimed in claim 11, wherein the method is carried out with a processing apparatus.

14. A method for shape fine processing of an optical lens by material removal with a turning tool in a turning process, wherein the optical lens is driven in rotation about a spindle axis and wherein a starting surface (F) having an inhomogeneous surface oversize (A) in relation to a fine processing target surface (ZF2) is processed with the turning tool, comprising:
(a) at least one oversize homogenization step by addressing the starting surface (F) with the turning tool in a noncircular orbit about the spindle axis by modulating a radial setting of the turning tool, with zones of the inhomogeneous surface oversize (A) comprising an increased surface oversize (A1) in relation to the fine processing target surface (ZF2) lying on the noncircular orbit, and modulating the axial setting of the turning tool in order to produce a homogeneous target oversize in relation to the fine processing target surface (ZF2), the penetration depth of the turning tool into the optical lens varying over the orbit; and
(b) a final processing step, in which the target oversize in relation to the fine processing target surface (ZF2) is removed with an at least substantially constant penetration depth of the turning tool over the orbit until the fine processing target surface (ZF2).

15. The method as claimed in claim 14, wherein the starting surface (F) corresponds to the geometrical data (D).
